(19) United States
(12) Patent Application Publication
(10) Pub. No.: US 2018/0198361 A1
(43) Pub. Date: Jul. 12, 2018

(54) MULTI CHANNEL SWITCHING CONVERTER

(71) Applicant: Silicon Mitus, Inc., Kyeonggi-do (KR)

(72) Inventors: Dong Hoon SEONG, Seoul (KR); Han Suk SEO, Seoul (KR); Jong Hun KIM, Gyeonggi-do (KR)

(21) Appl. No.: 15/856,930

(22) Filed: Dec. 28, 2017

(30) Foreign Application Priority Data
Jan. 9, 2017 (KR) 10-2017-0003079
Feb. 22, 2017 (KR) 10-2017-0023523

(51) Int. Cl. H02M 1/08; H02M 3/156

(52) U.S. Cl. CPC H02M 1/08; H02M 2001/0083; H02M 3/156

(57) ABSTRACT

The present disclosure provides a multi-channel switching converter which may be operated from a plurality of energy sources, using multiple channels, and may effectively maintain an output voltage by driving the switching converter from any one energy source or a plurality of energy sources that are most suitable in consideration of input voltages of the plurality of energy sources and may provide an output through another energy source even though a problem occurs in some of the plurality of energy sources.

### CROSS REFERENCE TO RELATED APPLICATION

This application claims priority from Korean Patent Application Nos. 10-2017-0003079 filed on Jan. 9, 2017 and 10-2017-0023523 filed on Feb. 22, 2017, which are hereby incorporated by reference for all purposes as if fully set forth herein.

### ACKNOWLEDGEMENT

This work was supported by Institute for Information & Communications Technology Promotion (IITP) grant funded by the Korea government (MSIT) (No. 2005-0-00322, Development of non-powered technology combined with ambient RF energy harvesting and Backscatter data transfer).

### BACKGROUND OF THE INVENTION

### 1. Field of the Invention

The present disclosure relates to a multi-channel switching converter that receives a plurality of input voltages and, more particularly, to a method of controlling a buck-boost converter that operates using a single or a plurality of input voltages according to the magnitude of the input voltage in multiple channels.

### 2. Description of the Prior Art

FIG. 1 illustrates a single-channel buck-boost converter. The buck-boost converter includes a plurality of switching elements S11 and S12 having the switching element S11 connected to an input voltage Vin, a plurality of diodes D11 and D12, an inductor L11, a capacitor C11, resistors R11 and R12, and a controller 10. The single-channel buck-boost converter may convert the voltage magnitude of the input voltage Vin and may supply the converted voltage magnitude to a load RL. The single-channel buck-boost converter may receive the input voltage Vin from one energy source for operation.

The buck-boost converter is typically implemented through pulse width modulation control, pulse frequency modulation control, or hysteresis control, each using an integrator. At this time, in order to stably maintain an output voltage, the input voltage must be supplied stably. When the input voltage is not supplied, energy cannot be transferred to the load, and therefore the output voltage cannot be maintained.

In a case of a single channel having one energy source, it is difficult to stably maintain the output voltage when the input voltage is not stably supplied. When the converter is driven using input voltages of multiple channels, the above-described problem of the single channel can be solved, and the output voltage can be stably maintained even when the voltage of any one energy source is not stably supplied. As an example of using the multiple channels, an energy harvesting system may be given. The energy harvesting system is a system that operates using various energy sources such as energy transmitted by RF, solar energy, batteries, and the like as inputs.

The present disclosure provides a method of stably maintaining an output while efficiently receiving energy from a plurality of energy sources by selecting a suitable channel according to input voltages of a plurality of channels, when multiple channels are used.

### SUMMARY OF THE INVENTION

In this background, an aspect of the present disclosure is to provide a switching converter which may be operated from a plurality of energy sources, using multiple channels, and may effectively maintain an output voltage by driving the switching converter from any one energy source or a plurality of energy sources that are most suitable in consideration of input voltages of the plurality of energy sources and may provide an output through another energy source even though a problem occurs in some of the plurality of energy sources.

In accordance with an aspect of the present disclosure, there is provided a multi-channel switching converter which receives a plurality of input voltages of a plurality of channels and generates an output voltage, including: a first switching unit configured to include a plurality of first switching elements, wherein each of the plurality of first switching elements is connected at one end thereof to each of the plurality of input voltages, and the other ends of the plurality of first switching elements are commonly connected to each other; and a controller configured to select the input voltage to receive energy among the input voltages of the plurality of channels, and to control the first switching unit to generate the output voltage using the selected input voltage.

Here, the controller may include an operation mode selector configured to generate an operation mode signal for selecting a channel to receive energy according to a magnitude of the input voltage of each channel, a clock signal generator configured to generate a channel clock signal of each channel by dividing a basic clock signal, a hysteresis comparator configured to generate a hysteresis comparison result signal by comparing an output feedback voltage and a reference value, and a switching control signal generator configured to receive the operation mode signal of the operation mode selector, the basic clock signal and channel clock signal of the clock signal generator, and the hysteresis comparison result signal of the hysteresis comparator, and to generate control signals of the first switching elements of the first switching unit.

Also, the operation mode selector may include an input voltage selector configured to generate an input voltage selection signal for selecting the input voltage to be used to generate the output voltage according to the magnitude of the input voltage of each channel, and an operation mode signal generator configured to receive the input voltage selection signal and to generate the operation mode signal.

Also, when the input voltage selection signal selects an input voltage of any one channel, the controller may control the first switching element corresponding to the selected input voltage to be turned on according to the basic clock signal and the hysteresis comparison result signal, and when the input voltage selection signal selects input voltages of two or more channels, the controller may control the first switching elements corresponding to the selected input voltages to be alternately turned on according to the basic clock signal, the channel clock signal of the corresponding channel, and the hysteresis comparison result signal.

Also, the input voltage selector may select the largest input voltage among the input voltages of the respective channels, and may select, when a magnitude of the input voltage other than the largest input voltage is equal to or greater than a predetermined ratio of the magnitude of the largest input voltage, the input voltage other than the largest input voltage together.

Also, the predetermined ratio may be set as 0.95.

Also, the turned-on first switching element may be turned off after a predetermined first time from the basic clock signal.

Also, when the hysteresis comparison result signal indicates turning-off of the converter, the controller may not turn on any of the first switching elements of the first switching unit in spite of the basic clock signal and the channel clock signal.

Also, the converter may be a buck-boost converter, and the buck-boost converter may include a first diode configured to have a cathode connected to a terminal to which the other ends of the plurality of first switching elements of the first switching unit are commonly connected and an anode connected to a reference potential, an inductor configured to have one end connected to the cathode of the first diode, a second switching element configured to have one end connected to the other end of the inductor and to have the other end connected to the reference potential, a second diode configured to have an anode connected to the other end of the inductor, and an output capacitor configured to have one end connected to a cathode of the second diode and to have the other end connected to the reference potential.

Also, the controller may divide a single channel operation mode in which one channel operates and a multi-channel operation mode in which a plurality of channels operate, and may control the first switching elements corresponding to the plurality of operating channels to be alternately turned on in the multi-channel operation mode.

Also, the controller may generate a turn-on signal of the first switching element using the basic clock signal in the single channel operation mode, and may generate the turn-on signal using the basic clock signal and the channel clock signal together in the multi-channel operation mode so that the first switching elements alternately operate.

As described above, according to embodiments of the present disclosure, the multi-channel switching converter may be operated from a plurality of energy sources, using multiple channels, and may effectively maintain an output voltage by driving the switching converter from any one energy source or a plurality of energy sources that are most suitable in consideration of input voltages of the plurality of energy sources and may provide an output through another energy source even though a problem occurs in some of the plurality of energy sources.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates a single-channel buck-boost converter;

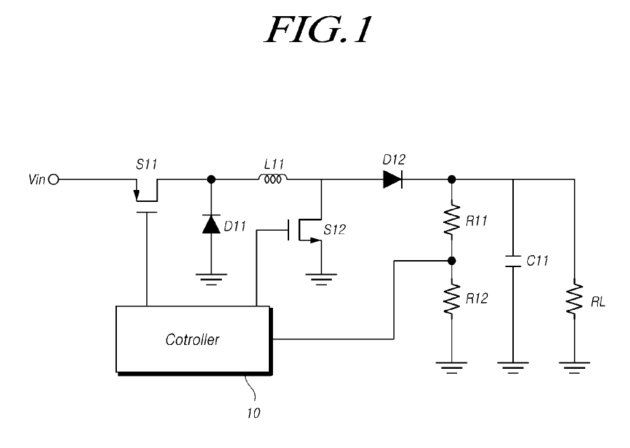

FIG. 2 illustrates a multi-channel switching converter according to an embodiment of the present disclosure;

FIG. 3 illustrates a multi-channel buck-boost converter according to an embodiment of the present disclosure;

FIG. 4 is an internal block diagram of a controller;

FIG. 5 illustrates an internal circuit of an input voltage selector;

FIG. 6 illustrates an internal circuit of an operation mode signal generator;

FIG. 7 illustrates the operation of a clock signal generator;

FIG. 8 illustrates an internal circuit of a switching control signal generator;

FIG. 9 illustrates an operation waveform of a multi-channel buck-boost converter according to an embodiment of the present disclosure;

FIG. 10 illustrates an internal circuit of a hysteresis comparator; and

FIG. 11 illustrates an operation waveform of a hysteresis comparator.

### DETAILED DESCRIPTION OF THE EXEMPLARY EMBODIMENTS

Hereinafter, embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

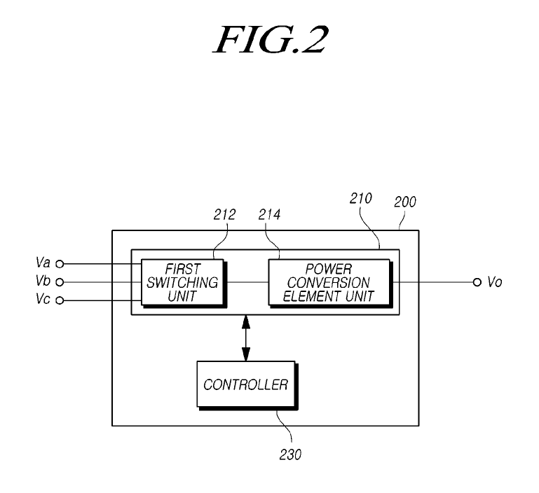

FIG. 2 is a block diagram of a multi-channel switching converter 200 according to an embodiment of the present disclosure. The multi-channel switching converter 200 may receive input voltages Va, Vb, and Vc of a plurality of channels to generate an output voltage Vo. To this end, the multi-channel switching converter 200 may include a power conversion unit 210 and a controller 230. In FIG. 2, the number of input channels is illustrated as being 3. However, the number of input channels is not limited thereto, and may be an appropriate number as needed.

The power conversion unit 210 may include a first switching unit 212 and a power conversion element unit 214. The power conversion unit 210 may receive energy from an input voltage selected from the plurality of input voltages Va, Vb, and Vc of the plurality of channels to convert the energy, and then may provide the converted energy as the output voltage Vo. Although a buck-boost converter is illustrated as the power conversion unit 210 in this specification, other power conversion circuits may be used.

The first switching unit 212 may include a plurality of switching elements. In order to receive energy from the input voltage selected from the input voltages Va, Vb, and Vc of the plurality of channels and supply the received energy to the power conversion element unit 214 provided at a rear end of the first switching unit 212, the first switching unit 212 may selectively connect the input voltage selected from the input voltages Va, Vb, and Vc to the power conversion element unit 214 provided at the rear end thereof.

The power conversion element unit 214 may include another switching element, a diode, an inductor, a capacitor, and the like, which are connected to the first switching unit 212 among the components of the power conversion unit 210 to perform a power conversion function. Elements included in the power conversion element unit 214 may vary depending on the type of a used power conversion circuit.

The controller 230 may control the first switching unit 212 and the power conversion element unit 214 so that the input voltage from which energy is to be received may be selected from the input voltages Va, Vb, and Vc of the plurality of channels and the output voltage Vo may be generated using the selected input voltage. Here, the input voltage selected from the input voltages Va, Vb, and Vc of the plurality of channels may be one input voltage having a maximum magnitude. However, when a plurality of input voltages have a similar magnitude and are sufficient to supply energy, it is possible to receive energy from the plurality of input voltages. For example, when any two input voltages among the plurality of input voltages Va, Vb, and Vc exhibit an approximate difference in a state sufficient to supply energy, the use of only one input voltage having the maximum value among the two input voltages may not be desirable in terms of efficient use of a plurality of energy sources, and therefore, in this case, it may be more effective to use two energy sources together. The operation of the controller 230 will be described in detail below.

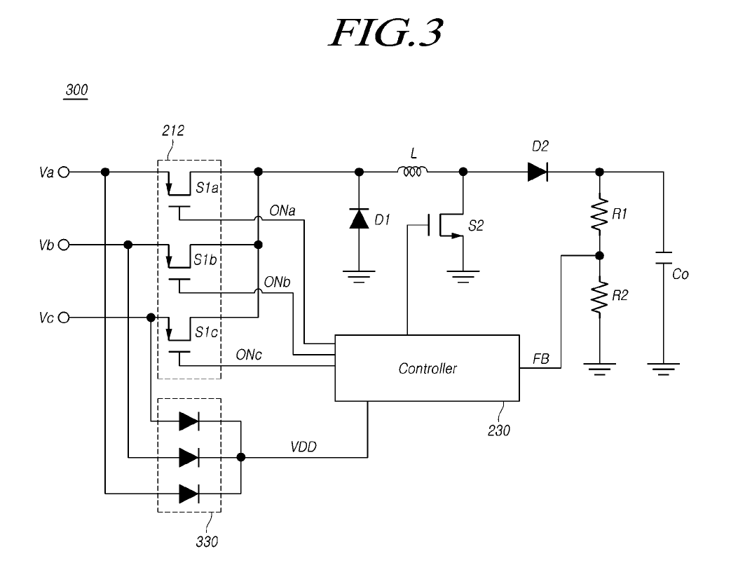

FIG. 3 illustrates a multi-channel buck-boost converter 300 according to an embodiment of the present disclosure. The multi-channel buck-boost converter 300 may include a first switching unit 212, a controller 230, a control power supply unit 330, a second switching unit S2, diodes D1 and D2, an inductor L, an output capacitor Co, and resistors R1 and R2.

The first switching unit 212 may include a plurality of first switching elements S1a, S1b, and S1c, and one ends of the plurality of first switching elements S1a, S1b, and S1c may be respectively connected to the plurality of input voltages Va, Vb, and Vc, and the other ends thereof may be commonly connected to each other. That is, the plurality of first switching elements S1a, S1b, and S1c of the first switching unit 212 is configured to correspond to the input voltages Va, Vb, and Vc of the plurality of channels so that, when it is desired to receive energy from the input voltage of any one channel, the corresponding first switching element may be driven.

The cathode of the first diode D1 may be connected to a terminal to which the other ends of the plurality of first switching elements S1a, S1b and S1c of the first switching unit 212 are commonly connected, and the anode thereof may be connected to a reference potential. The reference potential may be grounded, but a potential that is a reference of the power conversion unit may be used even if it is not grounded.

The inductor L may have one end connected to the cathode of the first diode D1 and the other end connected to one end of the second switching element S2.

One end of the second switching element S2 may be connected to the other end of the inductor L, and the other end thereof may be connected to the reference potential.

The anode of the second diode D2 may be connected to the other end of the inductor L and the cathode thereof may be connected to one end of the output capacitor Co.

The output capacitor Co may be connected at one end thereof to the cathode of the second diode D2 and at the other end thereof to the reference potential.

The control power supply unit 330 may generate a control power supply VDD from the input voltages Va, Vb, and Vc of the plurality of channels. The control power supply unit 330 may generate the control power supply VDD by connecting the anodes of three diodes respectively to the input voltages Va, Vb, and Vc and connecting the cathodes of the three diodes commonly. In this case, the control power supply VDD can be supplied in such a manner that the input voltage having the largest value among the input voltages Va, Vb, and Vc supplies power to the control power supply VDD through the corresponding diode and diodes of other channels are turned off.

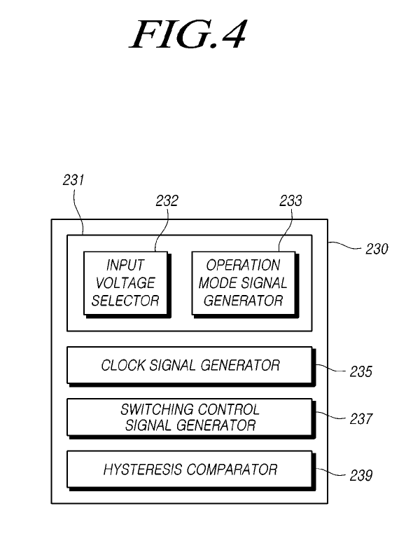

FIG. 4 is an internal block diagram of the controller 230. The controller 230 may include an operation mode selector 231, a clock signal generator 235, a switching control signal generator 237, and a hysteresis comparator 239. The controller 230 may select an input voltage to be supplied with energy among input voltages of a plurality of channels, and may control the first switching unit to generate an output voltage using the selected input voltage.

The operation mode selector 231 may perform a function of selecting a channel to receive energy according to the magnitude of the input voltage of each channel. To this end, the operation mode selector 231 may include an input voltage selector 232 and an operation mode signal generator 233.

The input voltage selector 232 may generate an input voltage selection signal to be used to select the input voltage which is used to generate the output voltage according to the magnitude of the input voltage of each channel.

The operation mode signal generator 233 may receive the input voltage selection signal generated by the input voltage selector 232, and may generate an operation mode signal including operation mode information.

The clock signal generator 235 may generate a channel clock signal of each channel by dividing a basic clock signal.

The hysteresis comparator 239 may generate a hysteresis comparison result signal by comparing an output feedback voltage with a reference voltage.

The switching control signal generator 237 may receive the operation mode signal of the operation mode selector 231, the channel clock signal of the clock signal generator 235, and the hysteresis comparison result signal of the hysteresis comparator 239, and may generate control signals of the first switching elements of the first switching unit.

Hereinafter, the input voltage selector 232, the operation mode signal generator 233, the clock signal generator 235, the switching control signal generator 237, and the hysteresis comparator 239 will be described in detail.

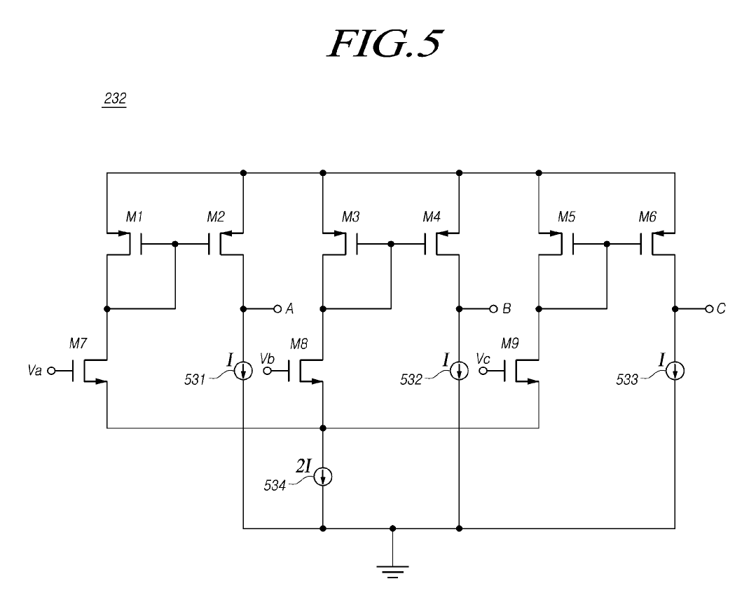

FIG. 5 illustrates an internal circuit of the input voltage selector 232. The input voltage selector 232 may include a plurality of current mirror circuits having a plurality of current sources 531, 532, 533, and 534 and a plurality of transistors M1 to M9. FIG. 5 illustrates a preferred embodiment for the input voltage selector 232. The input voltage selector 232 is not limited to the circuit illustrated in FIG. 5, and various modifications may be possible. Although FIG. 5 illustrates the use of input voltages Va, Vb, and Vc of three input channels, the number of input channels can be changed, as necessary.

The input voltage selector 232 may perform a function of adjusting ratios of the current sources 531, 532, 533, and 534 to select the input voltage to be supplied with energy. The input voltage selected from the input voltages Va, Vb, and Vc of the plurality of channels may be one input voltage having a maximum amplitude. However, when a plurality of input voltages have a similar magnitude and are in a state sufficient to supply energy, it is possible to be supplied with energy from the plurality of input voltages. For example, when any two input voltages among the plurality of input voltages Va, Vb, and Vc exhibit an approximate difference in a state sufficient to supply energy, the use of only one input voltage having a maximum value among the two input voltages may not be desirable in terms of efficient use of a plurality of energy sources, and therefore, in this case, it may be more effective to use two energy sources together.

To this end, the input voltage selector 232 may select the largest input voltage among the input voltages Va, Vb, and Vc of the respective channels, and at the same time, may select, when the magnitude of the input voltage other than the largest input voltage is equal to or greater than a predetermined ratio of the magnitude of the largest input voltage, the corresponding input voltage as well. Here, the predetermined ratio, which is a criterion for selecting an input voltage other than the largest input voltage, can be set as various values. For example, when the input voltage other than the largest input voltage is 0.95 or more of the largest input voltage, the input voltage can be set to be selected as well.

Input voltage selection signals A, B and C, which are outputs of the input voltage selector 232 according to the input voltages Va, Vb, and Vc of the three channels, may be determined in the following manner.

1) When Va>Vb and Va>Vc is satisfied, A=1, B=0, C=0

2) When Vb>Va and Vb>Vc is satisfied, A=0, B=1, C=0

3) When Vc>Va and Vc>Vb is satisfied, A=0, B=0, C=1

4) When Va=Vb>Vc is satisfied, A=1, B=1, C=0

5) When Va=Vc>Vb is satisfied, A=1, B=0, C=1

6) When Vb=Vc>Va is satisfied, A=0, B=1, C=1

7) When Va=Vb=Vc is satisfied, A=0, B=0, C=0

It is apparent that the above logic output of the input voltage selector 232 is merely an example and the logic output thereof can be configured in various ways including input voltage selection information. For example, a value of “1” is illustrated as being assigned to the largest input voltage channel, but a value of “0” may be assigned to the largest input voltage channel. In addition, the fact that two input voltages are equal to each other as in the case of “Va=Vb” above does not mean only a case in which the two input voltages have substantially the same value, but may include a case in which it is preferable to receive energy from the two input voltages as a case in which the two input voltages have a difference equal to or less than the predetermined ratio as described above.

In this manner, the input voltage selector 232 may compare the magnitudes of the input voltages Va, Vb, and Vc of the plurality of channels to select a channel to receive energy, and may generate the input voltage selection signals A, B, and C as a result.

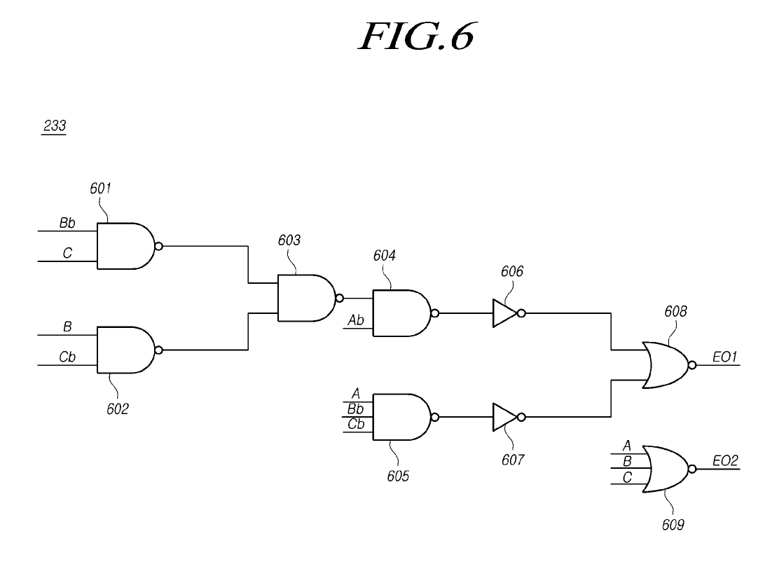

FIG. 6 illustrates an internal circuit of the operation mode signal generator 233. The operation mode signal generator 233 may output operation mode signals EO1 and EO2, using the input voltage selection signals A, B, and C which are the outputs of the input voltage selector 232 and inverted signals Ab, Bb, and Cb (for example, when A=1 is satisfied, Ab=0) of the input voltage selection signals A, B, and C. To this end, the operation mode signal generator 233 may be implemented using a plurality of logic circuits such as NAND logic circuits 601, 602, 603, 604, and 605, INVERTER logic circuits 606 and 607, and NOR logic circuits 608 and 609. The specific implementation of the operation mode signal generator 233 illustrated in FIG. 6 is one preferred example, and a specific circuit for performing the function of the operation mode signal generator 233 described in this embodiment may be variously modified.

The operation mode signals EO1 and EO2 which are the outputs of the operation mode signal generator 233 illustrated in FIG. 6 may be operated in the following manner.

1) When Va>Vb and Va>Vc is satisfied (A=1, B=0, C=0), EO1=0, EO2=0

2) When Vb>Va and Vb>Vc is satisfied (A=0, B=1, C=0), EO1=0, EO2=0

3) When Vc>Va and Vc>Vb is satisfied (A=0, B=0, C=1), EO1=0, EO2=0

4) When Va=Vb>Vc is satisfied (A=1, B=1, C=0), EO1=1, EO2=0

5) When Va=Vc>Vb is satisfied (A=1, B=0, C=1), EO1=1, EO2=0

6) When Vb=Vc>Va is satisfied (A=0, B=1, C=1), EO1=1, EO2=0

7) When Va=Vb=Vc is satisfied (A=0, B=0, C=0), EO1=1, EO2=1

That is, the operation mode signal generator 233 may generate the operation mode signals EO1 and EO2 through which three cases, that is, cases where the maximum number of input voltages to be used is respectively 1, 2, and 3 can be distinguished. When the operation mode signals EO1 and EO2 are divided in this manner, a method of generating a switching control signal may be changed in the cases where the number of input voltages to be used is respectively 1, 2, and 3 (This part will be described in detail below). That is, it can be understood that a case where the operation mode signal EO1=0 is satisfied indicates a single channel operation mode in which only one channel operates, and a case where the operation mode signal EO1=1 is satisfied indicates a multi-channel operation mode in which two or more channels operate. A method of generating the operation mode signal by the operation mode signal generator 233 and the output of the operation mode signal are not limited to the above examples, and the method of generating the operation mode signal that can be divided into a mode in which a single channel operates and a mode in which a plurality of channels operate can be variously modified.

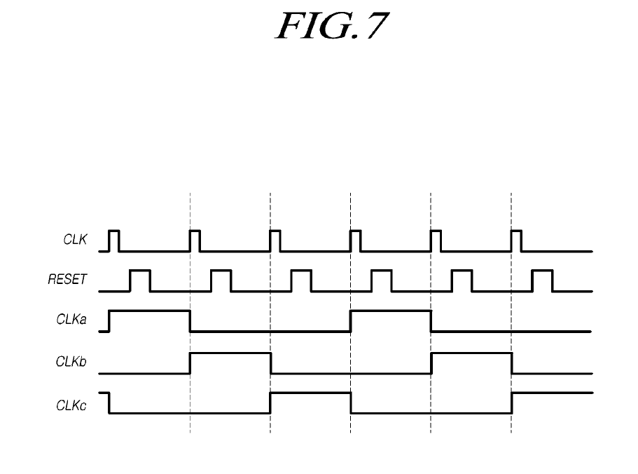

FIG. 7 illustrates the operation of the clock signal generator 235. The clock signal generator 235 may generate channel clock signals CLKa, CLKb, and CLKc of respective channels using a basic clock signal CLK. The clock signal generator 235 may generate the channel clock signals CLKa, CLKb, and CLKc of the respective channels by dividing the basic clock signal CLK by the number corresponding to the number of channels. Since a divider circuit for the clock signal is generally known in this field, a detailed description thereof will be omitted. The basic clock signal CLK may be generated at a predetermined frequency. The channel clock signals CLKa, CLKb, and CLKc of the respective channels can be utilized to generate the switching control signal of the corresponding channel. Although FIG. 7 illustrates generation of the three channel clock signals CLKa, CLKb, and CLKc assuming three channels, the number of channels is not limited to three.

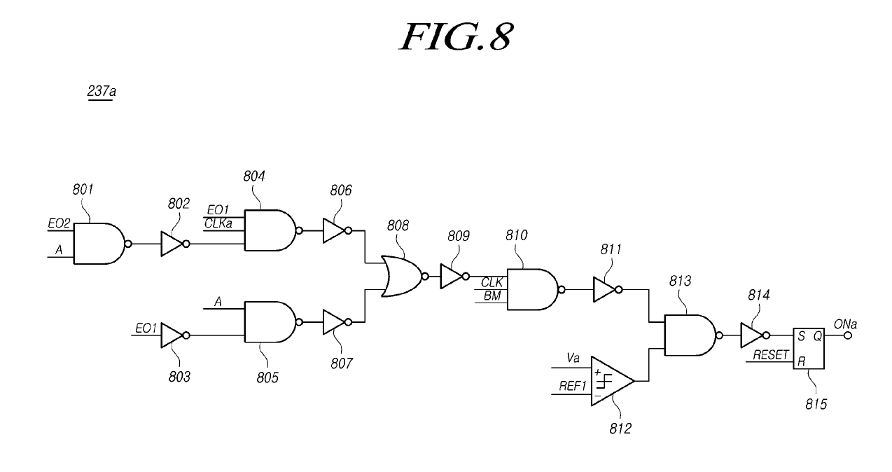

FIG. 8 illustrates an internal circuit of a switching control signal generator 237a of a channel A. The switching control signal generator 237 of FIG. 4 may include the switching control signal generator 237a illustrated in FIG. 8 for each channel, and may generate switching control signals ONa, ONb, and ONc for controlling the first switching element of the corresponding channel.

The switching control signal generator 237a of the channel A may generate a switching control signal ONa using at least one of the input voltage Va, the input voltage selection signal A, the operation mode signals EO1 and EO2, the basic clock signal CLK, the channel clock signal CLKa, a hysteresis comparison result signal BM, a first reference signal REF1, and a reset signal RESET.

To this end, the switching control signal generator 237a may be implemented using a plurality of logic circuits such as NAND logic circuits 801, 804, 805, 810 and 813, INVERTER logic circuits 802, 803, 806, 807, 809, 811, and 814, a NOR logic circuit 808, a comparator 812, an RS flip-flop 815, and the like. The specific implementation of the switching control signal generator 237a illustrated in FIG. 8 is one preferred example, and a specific circuit for performing the function of the switching control signal generator 237a described in this embodiment may be variously modified. Since the switching control signal generator 237a illustrated in FIG. 8 is for the channel A, in cases of channels B and C, the input voltage selection signal A, the channel clock signal CLKa, and the input voltage Va which are signals for the channel A in FIG. 8 may be changed to signals of the corresponding channel.

Since the input voltage Va, the input voltage selection signal A, the operation mode signals EO1 and EO2, the basic clock signal CLK, and the channel clock signal CLKa among the signals used in the switching control signal generator 237a have been described above, the hysteresis comparison result signal BM, the first reference signal REF1, and the reset signal RESET will be described below.

The first reference signal REF1 may be used to prevent a corresponding switching converter from operating when the input voltage Va is less than or equal to a reference value. To this end, the switching control signal ONa may be generated only when the input voltage Va is equal to or greater than the first reference signal REF1 based on comparison therebetween. However, the condition for causing the switching control signal ONa to be generated by comparing the input voltage Va with the first reference signal REF1 may not be used depending on the situation.

The reset signal RESET can be used to generate a signal for turning off a corresponding switching element. In the embodiment of FIG. 8, when a “High” signal is applied to the reset signal RESET, a flip-flop 815 is reset so that the switching control signal ONa of the channel A, which is the output of the reset, indicates a “Low” signal and the first switching element of the channel A may be turned off by the “Low” signal. By way of example, the basic clock signal CLK may be generated at a predetermined frequency, and the reset signal RESET may be generated after a predetermined time delay from the basic clock signal CLK using a time delay element. In this case, the corresponding switching converter operates in a manner having a fixed frequency and a fixed turn-on time, and the control of a corresponding output voltage may be achieved by adjusting the frequency of a period in which a turn-on interval is generated and the frequency of a period in which no turn-on interval is generated. As will be described below, the output of the hysteresis comparator can be used to determine whether to generate the turn-on interval in a predetermined period.

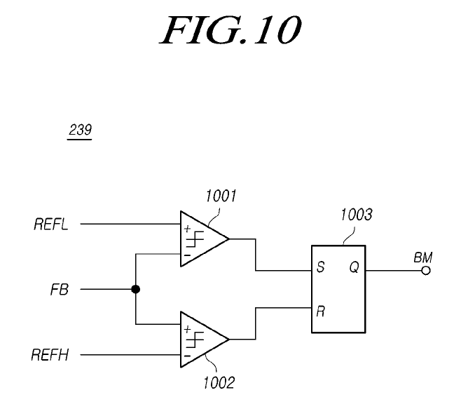

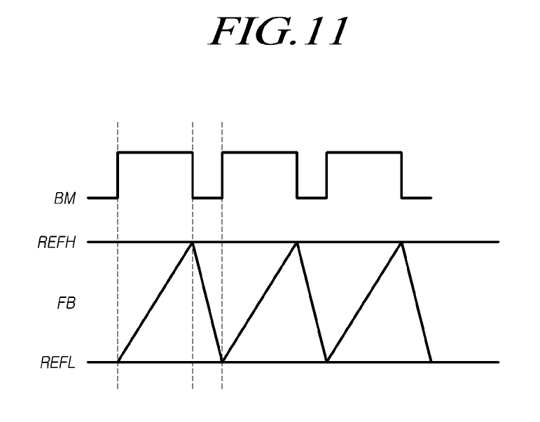

The hysteresis comparison result signal BM will be described with reference to FIGS. 10 and 11. Referring to FIG. 10, the hysteresis comparator 239 may include two comparators 1001 and 1002 and a flip-flop 1003.

A lower limit reference value REFL is input to a positive input terminal of the first comparator 1001 and an output feedback voltage FB is input to a negative input terminal thereof. The output feedback voltage FB is input to a positive input terminal of the second comparator 1002 and an upper limit reference value REFH is input to a negative input terminal thereof. The output of the first comparator 1001 is input to a set terminal S of the flip-flop 1003 and the output of the second comparator 1002 is input to a reset terminal R of the flip-flop 1003. According to such a hysteresis comparator 239, as illustrated in FIG. 11, the hysteresis comparison result signal BM may be switched to “low” at the time when the output feedback voltage FB rises and meets the upper limit reference value REFH, and may be switched to “high” at the time when the output feedback voltage FB falls and meets the lower limit reference value REFL. That is, the hysteresis comparator 239 may output a comparison result of the output feedback signals FB in a hysteresis manner in the range from the upper limit reference value REFH to the lower limit reference value REFL, as the hysteresis comparison result signal BM.

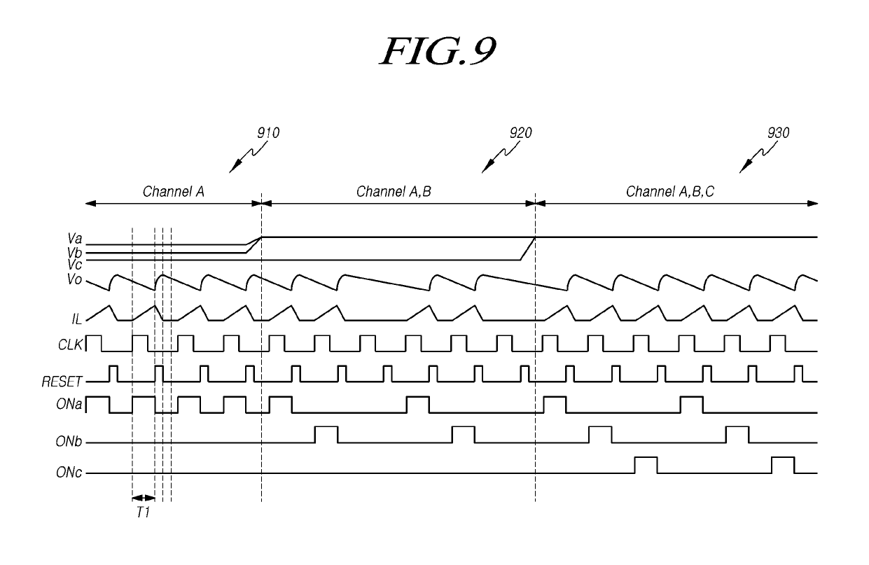

The operation of the switching control signal generator 237a will now be described with reference to FIGS. 8 and 9. FIG. 9 illustrates an operation waveform of a multi-channel buck-boost converter according to an embodiment of the present disclosure. In FIG. 9, Va, Vb, and Vc denote input voltages of respective channels, Vo denotes an output voltage, IL denotes an inductor current, CLK denotes a basic clock signal, RESET denotes a reset signal, and ONa, ONb and ONc denote switching control signals of respective channels.

In FIG. 9, a first interval 910 is an interval in which the channel A operates as a case of Va>Vb>Vc, a second interval 920 is an interval in which the channels A and B operate simultaneously as a case of Va=Vb>Vc, and a third interval 930 is an interval in which the channels A, B, and C operate simultaneously as a case of Va=Vb=Vc.

First, in the first interval 910, when the basic clock signal CLK is switched to “High”, the switching control signal ONa becomes “High” and the first switching element of the channel A is turned on, so that an inductor current IL increases while energy is supplied to a corresponding inductor. When the reset signal RESET is applied after the lapse of a predetermined time T1 from the basic clock signal CLK, energy may be transferred from the input voltage of the channel A to an output capacitor in such a manner that the switching control signal ONa becomes “Low” to turn off the first switching element of the channel A and the energy stored in the inductor is transferred to the output capacitor so that the output voltage Vo increases.

The first switching element of the channel A may be turned on at every generation of the basic clock signal CLK in the first interval 910. Here, whether to turn on the first switching element of the channel A in each period may be determined in consideration of the hysteresis comparison result signal BM. When the output voltage Vo becomes higher than the upper limit reference value REFH, even if the first switching element of the channel A can be turned on by the basic clock signal CLK, the first switching element of the channel A may not be turned on by the hysteresis comparison result signal BM. That is, the first switching element corresponding to the input voltage of the selected channel may be turned on according to the basic clock signal CLK and the hysteresis comparison result signal BM in an interval in which any one of the channels is selected. In addition, as described above, whether to turn on the first switching element may be determined in consideration of a result obtained by comparing the input voltage Va with the first reference value REF1.

In the first interval 910, the first switching element may be turned off using the reset signal RESET. As an example of a method of generating the reset signal RESET, as described above, the basic clock signal CLK may be generated at a predetermined frequency and the reset signal RESET may be generated after the lapse of the predetermined first time T1 from the basic clock signal CLK. In this case, the corresponding switching converter operates in a manner having a fixed frequency and a fixed turn-on time, and the control of the output voltage Vo may be achieved by adjusting the frequency of a period in which a turn-on interval is generated and the frequency of a period in which no turn-on interval is generated. Whether to generate the turn-on interval in a predetermined period may be determined by the hysteresis comparator which compares the output voltage Vo with the reference values REFH and REFL. That is, when the hysteresis comparison result signal BM indicates turning-off of the corresponding converter (when the output voltage is higher than the upper limit reference value REFH), the first switching element corresponding to any channel may not be turned on in spite of the basic clock signal CLK and the channel clock signals CLKa, CLKb and CLKc.

Next, the second interval 920 is an interval in which the channel A and the channel B operate together. In the interval in which two channels operate together, there is a difference in operation as compared to the interval in which only one channel operates as in the first interval 910. In the second interval 920, two channels can operate together. Here, it is possible to cause the two channels to operate alternately, without causing any one channel to operate continuously every time the basic clock signal CLK is generated. To this end, as described with reference to FIG. 7, after generating the channel clock signals CLKa, CLKb, and CLKc by dividing the basic clock signal CLK, the switching control signal generator 237a of FIG. 8 logically combines the channel clock signals CLKa, CLKb, and CLKc with the operation mode signals EO1 and EO2, so that, a case in which the basic clock signal CLK and the channel clock signal CLKa, CLKb, or CLKc of the corresponding channel become simultaneously “high” when two or more channels operate may be used as a condition that the first switching element of the corresponding channel is turned on. Of course, as mentioned above, whether the hysteresis comparison result signal BM indicates turning-on of the converter may also be considered. In the second interval 920 using two channels together, the two channels may alternately operate using the channel clock signals CLKa, CLKb, and CLKc together. That is, when the input voltage selector selects the input voltages of two or more channels, the first switching elements corresponding to the selected input voltages of the channels may be turned on according to the basic clock signal CLK, the clock signal CLKa, CLKb or CLKc of the corresponding channel, and the hysteresis comparison result signal BM.

In this manner, when one channel operates using the operation mode signals EO1 and EO2 through which the cases in which one, two, or three channels are used can be distinguished, the first switching element of the corresponding channel can be turned on according to the basic clock signal CLK. In a case in which two or more channels operate, when the basic clock signal CLK and the channel clock signal CLKa, CLKb or CLKc of the corresponding channel are simultaneously “high”, the first switching element of the corresponding channel can be turned on.

Next, except that all three channels operate and three switching control signals ONa, ONb, and ONc are alternately generated under the condition of Va=Vb=Vc, the third interval 930 may be operated in a manner similar to that of the second interval 920.

As described above, according to the embodiments of the present disclosure, the multi-channel switching converter may be operated from a plurality of energy sources, using multiple channels, and may effectively maintain an output voltage by driving the switching converter from any one energy source or a plurality of energy sources that are most suitable in consideration of input voltages of the plurality of energy sources and may provide an output through another energy source even though a problem occurs in some of the plurality of energy sources.

In addition, according to embodiments of the present disclosure, the multi-channel switching converter may include the input voltage selector and the operation mode signal generator, thereby selecting one or a plurality of channels suitable for receiving energy by comparing the magnitudes of input voltages of a plurality of channels. In addition, by varying a method of generating the switching control signal, using the operation mode signal including information about whether one channel was selected or a plurality of channels were selected, the selected channel may operate every time the basic clock signal is generated when one channel is selected, and the selected channels may operate alternately when a plurality of channels is selected.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

What is claimed is:

1. A multi-channel switching converter which receives a plurality of input voltages of a plurality of channels and generates an output voltage, comprising:
a first switching unit configured to include a plurality of first switching elements, wherein each of the plurality of first switching elements is connected at one end thereof to each of the plurality of input voltages, and the other ends of the plurality of first switching elements are commonly connected to each other; and
a controller configured to select the input voltage to receive energy among the input voltages of the plurality of channels, and to control the first switching unit to generate the output voltage using the selected input voltage.

2. The multi-channel switching converter of claim 1, wherein the controller includes
an operation mode selector configured to generate an operation mode signal for selecting a channel to receive energy according to a magnitude of the input voltage of each channel,
a clock signal generator configured to generate a channel clock signal of each channel by dividing a basic clock signal,
a hysteresis comparator configured to generate a hysteresis comparison result signal by comparing an output feedback voltage and a reference value, and
a switching control signal generator configured to receive the operation mode signal of the operation mode selector, the basic clock signal and channel clock signal of the clock signal generator, and the hysteresis comparison result signal of the hysteresis comparator, and to generate control signals of the first switching elements of the first switching unit.

3. The multi-channel switching converter of claim 2, wherein the operation mode selector includes
an input voltage selector configured to generate an input voltage selection signal for selecting the input voltage to be used to generate the output voltage according to the magnitude of the input voltage of each channel, and
an operation mode signal generator configured to receive the input voltage selection signal and to generate the operation mode signal.

4. The multi-channel switching converter of claim 3, wherein, when the input voltage selection signal selects an input voltage of any one channel, the controller controls the first switching element corresponding to the selected input voltage to be turned on according to the basic clock signal and the hysteresis comparison result signal, and
when the input voltage selection signal selects input voltages of two or more channels, the controller controls the first switching elements corresponding to the selected input voltages to be alternately turned on according to the basic clock signal, the channel clock signal of the corresponding channel, and the hysteresis comparison result signal.

5. The multi-channel switching converter of claim 3, wherein the input voltage selector selects the largest input voltage among the input voltages of the respective channels, and selects, when a magnitude of the input voltage other than the largest input voltage is equal to or greater than a predetermined ratio of the magnitude of the largest input voltage, the input voltage other than the largest input voltage together.

6. The multi-channel switching converter of claim 5, wherein the predetermined ratio is set as 0.95.

7. The multi-channel switching converter of claim 4, wherein the turned-on first switching element is turned off after a predetermined first time from the basic clock signal.

8. The multi-channel switching converter of claim 7, wherein, when the hysteresis comparison result signal indicates turning-off of the converter, the controller does not turn on any of the first switching elements of the first switching unit in spite of the basic clock signal and the channel clock signal.

9. The multi-channel switching converter of claim 1, wherein the converter is a buck-boost converter, and the buck-boost converter includes
a first diode configured to have a cathode connected to a terminal to which the other ends of the plurality of first switching elements of the first switching unit are commonly connected and an anode connected to a reference potential,
an inductor configured to have one end connected to the cathode of the first diode,
a second switching element configured to have one end connected to the other end of the inductor and to have the other end connected to the reference potential,
a second diode configured to have an anode connected to the other end of the inductor, and
an output capacitor configured to have one end connected to a cathode of the second diode and to have the other end connected to the reference potential.

10. The multi-channel switching converter of claim 1, wherein the controller divides a single channel operation mode in which one channel operates and a multi-channel operation mode in which a plurality of channels operate, and controls the first switching elements corresponding to the plurality of operating channels to be alternately turned on in the multi-channel operation mode.

11. The multi-channel switching converter of claim 10, wherein the controller
generates a turn-on signal of the first switching element using the basic clock signal in the single channel operation mode, and
generates the turn-on signal using the basic clock signal and the channel clock signal together in the multi-channel operation mode so that the first switching elements alternately operate.
